(19) United States
(12) Patent Application Publication
(10) Pub. No.: US 2014/0318309 A1
(43) Pub. Date: Oct. 30, 2014

(54) Universal Bicycle Pedal

(71) Applicant: Bell Sports, Inc., Scotts Valley, CA (US)

(72) Inventors: Henry David Hayes, Eureka, CA (US); Sky Lo Yau Kai, Hong Kong (CN)

(21) Appl. No.: 13/871,111

(22) Filed: Apr. 26, 2013

(51) Int. Cl. B62M 3/08

(52) U.S. Cl. CPC B62M 3/08
USPC 74/594.4

(57) ABSTRACT

A universal pedal system in which adapter spindles with male threads on each end are mated to a pedal having a female threaded connector in order to provide universal adaptability without increasing pedal width substantially and thus avoiding altering bicycle fit or performance in an undesirable manner.

### FIELD OF THE INVENTION

The present invention relates to bicycles, and more particularly to pedal systems for bicycles.

### BACKGROUND

The importance of bicycles as a mode of transportation is well recognized. Bicycle transport presents significant economic advantages as has been recognized in numerous studies, for example, The Economic Significance of Cycling, VNG uitgeverij, The Hague 2000. Transportation using bicycles also provides beneficial health effects. See for example, Bicycling for Transportation and Health: The Role of Infrastructure, J. Public Health Policy (2009) 30, S95-S110. In order to maximize benefits obtainable by the use of bicycle transportation, it is helpful if bicycle riders are able to utilize properly fitted bicycles for each individual rider's physical characteristics and preferences regarding type of use and aesthetics.

Many bicycle components offer multiple options selectable by a rider to suit their particular aesthetic and functional requirements. One of those components is the bicycle pedal. A typical bicycle pedal is provided with a threaded stud that is screwed into a threaded hole or eye on the crank arm of the crank set. This allows for pedal interchangeability and replacement. However, a complication can be presented in that conventional bicycles are provided having at least two different sized threaded eyes on the crank arm. Depending on factors such as whether the crank set is a single piece or multi-piece, or the bicycle is intended for adult or child use, the diameter of the threaded eye may be either 9/16 inch or ½ inch.

Most casual users of bicycles do not realize that there are different sized threaded eyes and bicycle crank arms. Moreover, because the difference in diameter between the two standard sizes is a mere sixteenth of an inch, an average consumer is generally not aware when or if they purchase a replacement pedal with the wrong diameter threaded connection.

The existence of these two standard eye sizes leads to complications for manufacturers and retail outlets. For example, twice the stock may be needed in each pedal design to meet customer requirements. Moreover incorrect purchases result in customer dissatisfaction and returns.

Ultimately rider satisfaction can be impacted, leading to reduction in bicycle use and thus not only loss of revenue by manufacturers and retail outlets, but also loss of economic and health benefits associated with bicycle use.

Past attempts to address the challenge presented by variations in crank arm eye diameter have been less than satisfactory. The most common attempted solution has been to provide an adapter that includes a threaded socket on one end to receive the pedal spindle and a new threaded spindle on the opposite end with the correct thread diameter for the intended crank arm. An example of such a prior adapter is shown, for example, in U.S. Patent Application Publication US2004/0055412. An adapter of this type can increase the pedal width of the bicycle, frequently referred to as Q factor, by as much as 38 mm compared to the OE or original equipment bicycle design pedal width.

FIGS. 3A and 3B illustrate the increase in Q factor with conventional pedal adapter A. FIG. 3A shows the Q factor (Q) as measured between the outside surfaces of the crank arm where the pedal would be seated. In FIG. 3B, the Q factor is increased by the length of the conventional pedal adapter A, which requires a socket that is effectively as long as the thickness of the conventional crank arm in order to securely receive the pedal spindle threads. Each such socket A may have a length of as much as 19 mm for a total increase of about 38 mm as mentioned above.

Because of the significant increase in Q factor, this type of previously proposed adapter can negatively impact the fit of a previously properly fitted bicycle by altering the bicycle structure in relationship to the rider's natural foot alignment (varus or valgus alignment) and by changing the pedal position thus effecting knee strain and reducing the power transferred from the leg to the bicycle. These negative effects can be exacerbated by cleated pedals because the feet are constrained in wider stance.

An unexpected or unappreciated increase in bicycle width can also present a safety concern. An increase in pedal width changes the riding performance, for example by reducing the turn radius as a result of reducing the amount of lean that is possible without the pedal striking the ground and by increasing the clearance width between obstacles. Bicycle infrastructure is designed with specific bicycle widths in mind. An increase in width as a result of existing pedal adapters may make it difficult for the user to utilize existing parking and locking structures. See for example, Torrance, et al., The Effects of On-Street Parking on Cyclist Route Choice and the Operational Behavior of Cyclists and Motorists, Report No. FHWA/TX-09/0-5755-1 Center for Transportation Research, The University of Texas at Austin (2008) (Conclusions of the study based in part on an average bicycle width of 2 feet. See p. 11).

As a result of these difficulties, there remains a need in the art for the pedal system that easily accommodates the two standard crank arm eye sizes without increasing substantially the pedal width or other performance characteristics of the bicycle.

### SUMMARY OF THE DISCLOSURE

Embodiments of the present invention provide a pedal system for use with plural bicycles having different size crank arm eyes. In one embodiment, the system may comprise a pedal body, a pedal axle rotatably received in the pedal body and defining a threaded hole at one end thereof, and plural adapter spindles. Each adapter spindle may comprise a first threaded end and a second threaded end, wherein the first threaded ends each comprise a common thread diameter end size configured to threadedly engage the threaded hole of the pedal axle, and each second end comprises a different thread diameter end size with each different thread diameter end size being individually configured to threadedly engage a different size crank arm eye size.

In further embodiments, each adapter spindle may have an overall length not exceeding about 28 mm and the first and second threaded ends may each have a threaded length not exceeding about 13 mm. The overall pedal width of a bicycle with such an exemplary pedal system installed in each crank eye may have an increased Q factor of not more than about 6-4 mm as compared to the OE Q factor.

In another exemplary embodiment of the present invention, a pedal system provides an increased Q factor of not more than about 8 mm for use with plural bicycles having different size crank arm eyes. Such an embodiment may comprise a pedal body, a pedal axle rotatably received in the pedal body and defining a threaded hole at one end thereof having a first thread diameter and pitch, and plural adapter spindles. Each such adapter spindle may comprise a first male threaded end with the first thread diameter and pitch matching the pedal axle threaded hole, a second male threaded end and a collar disposed between the threaded ends. The second male threaded end of each of said plural adapter spindles may comprise a different thread size with each different thread diameter size being different than the first thread diameter and being individually configured to threadedly engage a different size crank arm eye size.

### BRIEF DESCRIPTION OF THE DRAWINGS

For the purposes of illustrating the invention, the drawings show aspects of one or more embodiments of the invention. However, it should be understood that the present invention is not limited to the precise arrangements and instrumentalities shown in the drawings, wherein:

FIG. 1 is a side view of a bicycle showing an enlarged detail of the bicycle crank set;

FIG. 2 is a perspective view of a pedal system according to one embodiment of the present invention; and

FIGS. 3A and 3B illustrate the Q factor dimension of a bicycle with and without pedal adapters.

### DETAILED DESCRIPTION

Embodiments of the present invention overcome disadvantages of prior art pedal adapters by providing a compact solution for interchangeability without substantially increasing the pedal width with a system that is easily installed and uninstalled by an average consumer/rider.

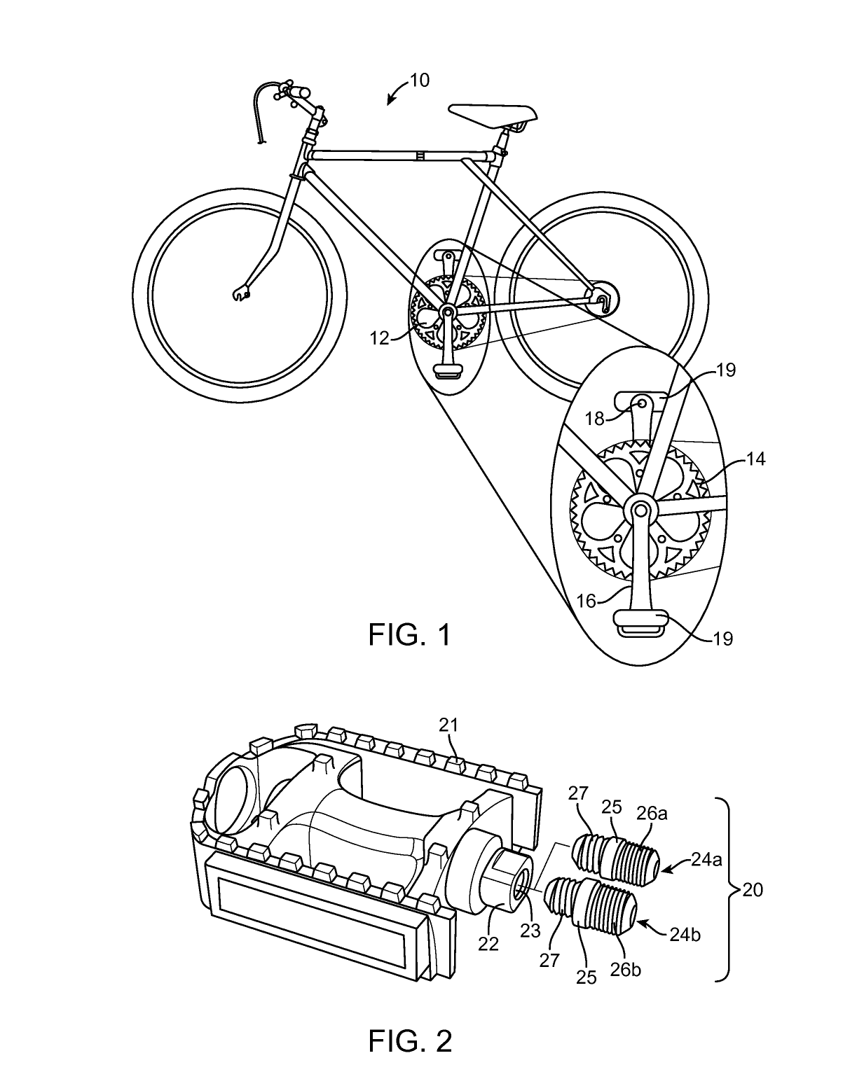

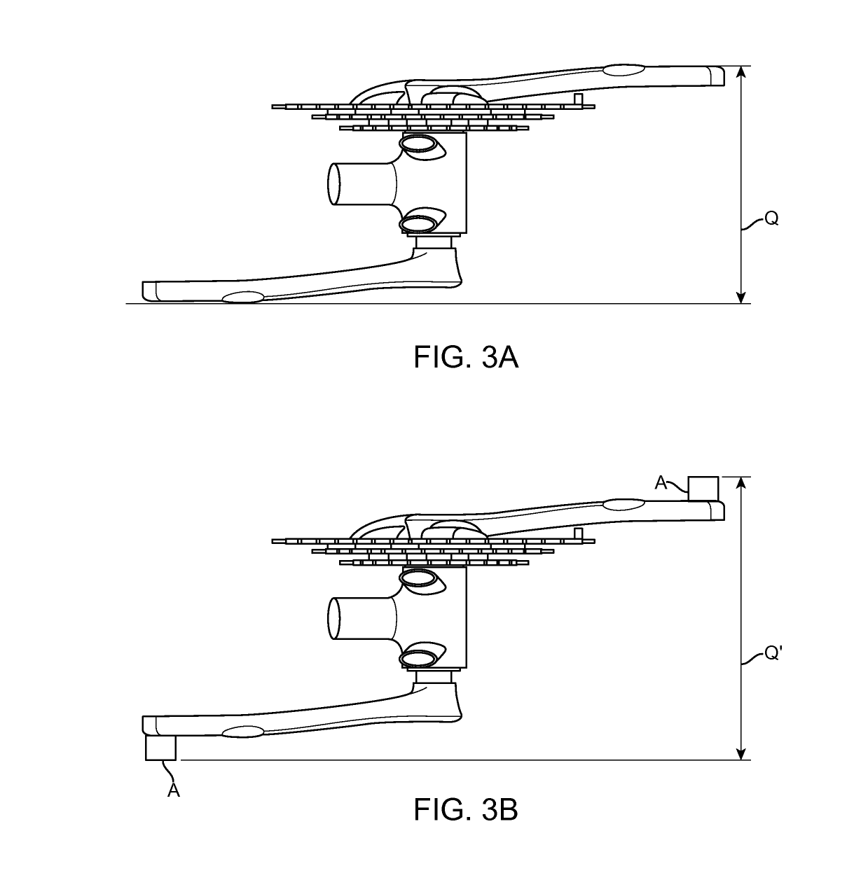

Turning to FIG. 1, a typical bicycle 10 includes a crank set 12. The crank set typically includes sprocket 14, crank arm 16 defining a threaded hole or eye 18 at its outer end into which a pedal 19 is secured by a threaded spindle. The standard size for the crank arm eye 18 is either 9/16 inch diameter or ½ inch diameter, usually each with 20 threads per inch. When a rider is dissatisfied with an existing pedal, whether for functional, wear or aesthetic reasons, the old pedal may be removed by unscrewing it from the crank eye 18 and installing the new pedal therein.

As mentioned above, problems arise when the rider fails to appreciate that a newly purchased pedal has an attachment spindle that is a mere 1/16 inch different in diameter from the crank eye diameter on his or her bicycle. This problem may be addressed, however, by a universal pedal system according to the present invention. As shown in FIG. 2, in one embodiment of the present invention, universal pedal system 20 includes a pedal body or cage 21 rotatably mounted on a pedal axle 23 in a conventional manner. Pedal axle 22, however, differs from a conventional pedal axle in that it is provided at its attachment end with a threaded hole 23. Also included as part of universal pedal system 20 are two pedal adapter spindles 24a and 24b, each with an end configured to be threaded into hole 23.

The adapter spindles each comprise a cylindrical body member, a central collar or ridge 25 and a threaded end 27 configured in size to engage threaded hole 23 in pedal axle 22. Opposite threaded end 27, and separated from the threaded end by collar 25, each pedal adapter spindle 24a, 24b is provided, respectively, with a different threaded end 26a and 26b configured to mate with each different size crank eye 18. As illustrated in FIG. 2, threaded end 26b has a 9/16 diameter with a 20 tooth per inch pitch and threaded end 26a has a ½ inch diameter with a 20 thread per inch pitch.

In one exemplary embodiment, the threaded connection between threaded axle hole 23 and threaded end 27 is selected with a different diameter and thread pitch as compared to threaded ends 26a, 26b so as to avoid confusion on the part of the rider or mechanic when installing the universal pedal on the proper size adapter spindle for the selected bicycle. Preferably the size is sufficiently different from the crank attachment end of the spindle adapter so as to be immediately obvious to the person making the installation. Other considerations such as strength and thread security may be determined or included based on material selection and other factors as determined by persons of ordinary skill in the art. In one example, the threaded connection between threaded hole 23 and threaded end 27 is a 10 mm diameter with 20 threads per inch.

In a further exemplary embodiment, adapter spindles 24a, 24b have an overall length that may be between about 26-29 mm, more preferably between about 26.5 mm and 27 mm, but generally not exceeding about 28 mm. The first and second threaded ends 26a, 26b and 27 may each have a threaded length between about 10-14 mm, but generally not exceeding about 13 mm. In such an exemplary embodiment, the overall pedal width of a bicycle employing the universal pedal system according to the present invention to install two replacement pedals may do so with an overall increased pedal width or Q factor of not more than about 8 mm, preferably not more than between about 6-4 mm, and more preferably not more than about 4 mm as compared to the OE or original bicycle design Q factor.

Exemplary embodiments have been disclosed above and illustrated in the accompanying drawings. It will be understood by those skilled in the art that various changes, omissions and additions may be made to that which is specifically disclosed in the embodiments described herein without departing from the spirit and scope of the present invention.

What is claimed is:

1. A pedal system for use with plural bicycles having different size crank arm eyes, comprising:
a pedal body;
a pedal axle rotatably received in the pedal body and defining a threaded hole at one end thereof;
plural adapter spindles, each said adapter spindle comprising a first threaded end and a second threaded end, wherein said first threaded ends each comprise a common thread diameter end size configured to threadedly engage the threaded hole of the pedal axle, and each said second end comprises a different thread diameter end size each said different thread diameter end size being individually configured to threadedly engage a different size crank arm eye size.

2. The pedal system of claim 1, wherein said first and second ends of each said adapter spindle are separated by a collar.

3. The pedal system of claim 1, wherein said first threaded end of each said adapter spindle comprises a thread having a diameter of 10 mm with 20 threads per inch.

4. The pedal system of claim 1, wherein each said adapter spindle has an overall length not exceeding about 28 mm and the first and second threaded ends each have a threaded length not exceeding about 13 mm.

5. The pedal system of claim 1, wherein the overall pedal width of a bicycle with said pedal system installed in each crank eye has an increased Q factor of not more than about 6-4 mm as compared to the OE Q factor.

6. A pedal system providing an increased Q factor of not more than about 8 mm for use with plural bicycles having different size crank arm eyes, comprising:
a pedal body;
a pedal axle rotatably received in the pedal body and defining a threaded hole at one end thereof having a first thread diameter and pitch; and
plural adapter spindles, each said adapter spindle comprising a first male threaded end with said first thread diameter and pitch matching said pedal axle threaded hole, a second male threaded end and a collar disposed between said threaded ends, wherein the second male threaded end of each of said plural adapter spindles comprises a different thread size, each said different thread diameter size being different than said first thread diameter and being individually configured to threadedly engage a different size crank arm eye size.

7. The pedal system of claim 6, wherein said system provides an increased Q factor of not more than about 4 mm as compared to the OE Q factor.

8. The pedal system of claim 7, wherein each said adapter spindle has an overall length between about 26-29 mm and the first and second threaded ends each have a threaded length of between about 10-14 mm.
